(19) United States
(12) Patent Application Publication
(10) Pub. No.: US 2026/0245531 A1
(43) Pub. Date: Aug. 20, 2026

(54) SOUND BAR FOR A MUSICAL INSTRUMENT AND METHOD OF MAKING THEREOF

(71) Applicant: Yale University, New Haven, CT (US)

(72) Inventors: Lawrence Wilen, New Haven, CT (US); Michael Toben, New Haven, CT (US); Konrad Kaczmarek, New Haven, CT (US)

(21) Appl. No.: 19/545,264

(22) Filed: Feb. 20, 2026

Related U.S. Application Data
(60) Provisional application No. 63/760,810, filed on Feb. 20, 2025.

(51) Int. Cl. G10D 13/08; G10D 13/10; G10D 13/24

(52) U.S. Cl. CPC G10D 13/08; G10D 13/24; G10D 13/25

(57) ABSTRACT

A sound bar comprising a prismatic bar having four faces, a first end and a second end, a first notch on a first face of the bar, and a second notch on a second face of the bar, wherein the first face is orthogonal to the second face. Also described herein is a method of making a sound bar, and a musical instrument comprising the sound bars.

### CROSS-REFERENCE TO RELATED APPLICATIONS

This applications claims priority to U.S. Provisional Patent Application No. 63/760,810 filed on Feb. 20, 2025, the contents of which are incorporated by reference herein in its entirety.

### BACKGROUND

Some percussive musical instruments include sound bars, each capable of playing a note of a specific tone or frequency corresponding to the fundamental vibrational mode. Higher vibrational modes can contribute slightly to the overall sound or timbre of the instrument, but they can be tuned in only a limited fashion to be related to the fundamental pitch.

Thus, there is a need in the art for sound bars capable of playing multiple tones, yielding a whole new range of possibilities for producing an instrument with a unique and novel sound (or “timbre”) or having a range of pitches that may be modulated into a different range of pitches performatively (i.e. while playing).

### SUMMARY

In some aspects, the present invention relates to a sound bar comprising a prismatic bar having four faces, a first end and a second end, a first notch on a first face of the bar, and a second notch on a second face of the bar, wherein the first face is orthogonal to the second face. In some embodiments, the length of the bar ranges between 1 and 200 cm, the width ranges between 1 and 10 cm, and the height ranges between 1 and 10 cm. In some embodiments, the first notch has a length ranging between 0.5 and 150 cm, and a depth ranging between 0 and 9.5 cm. In some embodiments, the second notch has a length ranging between 0.5 and 150 cm, and a depth ranging between 0 and 9.5 cm. In some embodiments, the sound bar is configured to produce a note having a first frequency when the first face is struck. In some embodiments, the sound bar is configured to produce a second note having a second frequency different from the first frequency when the second face is struck. In some embodiments, the sound bar further comprises a fifth face positioned between the first and second orthogonal faces. In some embodiments, the sound bar is configured to produce a note having a combination of the first and second frequencies when the fifth face is struck. In some embodiments, the frequencies of the first note and the second note are adjustable. In some embodiments, the first note and the second note may be related by a specified musical interval. In some embodiments, the sound bar further comprises first and second anchoring points at which the bar is secured to an external structure, wherein the position of the first and second anchoring points are adjustable.

In some aspects, the present invention relates to a method of making and tuning a sound bar to multiple target frequencies, comprising (a) measuring the frequency of an uncut sound bar, (b) determining a first and a second target frequency, (c) calculating a first and a second notch size based on the first and second target frequency, (d) cutting into the bar on the first face to the calculated first size, and on the second face to the calculated second size, (e) measuring the first and second new frequencies of the cut bar, and (f) iteratively repeating the steps (a)-(e) based on the measured new frequencies until the multiple target frequencies are reached.

In some aspects, the present invention relates to a musical instrument comprising one or more sound bars, each sound bar comprising a prismatic bar having four faces, a first end and a second end, a first notch on a first face of the bar, and a second notch on a second face of the bar, wherein the first face is orthogonal to the second face, and a first base rod and a second base rod positioned parallel to each other, wherein the one or more sound bars are positioned perpendicular to the base rods, and each sound bar is attached at a first position to the first base rod, and at a second position to the second base rod. In some embodiments, the first and second base rods are covered by a soft material chosen from the group consisting of foam, rubber, silicone, and soft polymers. In some embodiments, the musical instrument further comprises a rotating mechanism configured to rotate the one or more sound bars. In some embodiments, the one or more sound bars are rotatable about 10°, about 20°, about 30°, about 40°, about 50°, about 60°, about 70°, about 80°, or about 90°. In some embodiments, the one or more sound bars are collectively rotatable about the same angle. In some embodiments, one or more subsets of the one or more sound bars are separably rotatable about different angles. In some embodiments, each sound bar of the one or more sound bars is separably rotatable about different angles. In some embodiments, the musical instrument further comprises a resonant tube system configured to enhance the volume or timbre of the notes produced by the plurality of sound bars.

### BRIEF DESCRIPTION OF THE DRAWINGS

The following detailed description of embodiments of the invention will be better understood when read in conjunction with the appended drawings. It should be understood, however, that the invention is not limited to the precise arrangements and instrumentalities of the embodiments shown in the drawings.

FIG. 1, comprising FIGS. 1A though 1B, depict two perspective views of an exemplary sound bar with two orthogonal notches of the same lengths but different depths.

FIG. 2, comprising FIGS. 2A through 2B, depict two perspective views of an exemplary sound bar with two orthogonal notches of different lengths and different depths.

FIG. 3, comprising FIGS. 3A through 3B, depict two perspective views of an exemplary sound bar with two orthogonal notches of different lengths and different depths with rounded notch edges.

FIG. 4, comprising FIGS. 4A through 4B, depict two perspective views of an exemplary sound bar with two orthogonal notches of different lengths and different depths with rounded notch edges and a flat section at the corner of the orthogonal faces.

FIG. 5, comprising FIGS. 5A through 5B, depict perspective views of an exemplary sound bar with two orthogonal notches of the same length and different depths.

FIG. 6, comprising FIGS. 6A through 6C, depict perspective views of an exemplary sound bar with two orthogonal curved notches of the same length and different depths.

FIG. 7, comprising FIGS. 7A through 7B, depict perspective views of an exemplary sound bar with two orthogonal curved notches of different widths and different depths.

FIG. 8, comprising FIGS. 8A through 8B, depict perspective views of an exemplary cylindrical sound bar with two orthogonal notches of the same length and different depths.

FIG. 9, comprising FIGS. 9A through 9C depict perspective views of an exemplary cylindrical sound bar with two radial orthogonal notches of the same length and different widths/radii.

FIG. 10, comprising FIGS. 10A through 10B, depict two perspective views of an exemplary sound bar with two orthogonal notches of the same length and depth, showing the vibrational motion of the sound bar when it is struck.

FIG. 11 depicts an exemplary musical instrument with a plurality of sound bars.

FIG. 12, comprising FIGS. 12A through 12D, depicts an exemplary flexible attachment of a sound bar to a base to form a musical instrument.

FIG. 13, comprising FIGS. 13A through 13E, depict exemplary plots showing the relationship between notch lengths and frequency.

FIG. 14 depicts a flowchart showing the steps to an exemplary method of making and tuning a sound bar.

### DETAILED DESCRIPTION

The following discussion omits or only briefly describes conventional features of marimbas, xylophones, or other percussive instruments that are apparent to those skilled in the art. Those of ordinary skill in the pertinent arts may thus recognize that other elements may be desirable and/or necessary to implement the devices, systems, and/or methods described herein. It is noted that various examples do not limit the scope of the claims attached hereto. Additionally, any examples set forth in this specification are intended to be non-limiting and merely set forth some of the many possible implementations for the appended claims. Further, particular features described herein can be used in combination with other described features in each of the various possible combinations and permutations. As such, it is understood that this detailed description is exemplary and explanatory only and is not restrictive of the broad inventive concepts upon which the examples disclosed herein are based.

Unless otherwise specifically defined herein, all terms are to be given their broadest reasonable interpretation. This includes meanings implied from the specification as well as meanings understood by those skilled in the art and/or as defined in dictionaries, treatises, etc.

It is noted that, as used in the specification and the appended claims, the singular forms “a”, “an,” and “the” include plural referents unless otherwise specified. The terms “includes” and/or “including,” when used in this specification, specify the presence of stated features, elements, and/or components, but do not preclude the presence or addition of one or more other features, steps, operations, elements, components, and/or groups thereof.

Relative terms such as “horizontal,” “vertical,” “up,” “down,” “top,” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation in actuality. Terms including “inwardly” versus “outwardly,” “longitudinal” versus “lateral” and the like are to be interpreted relative to one another or relative to axis of elongation, or an axis or center of rotation, as appropriate. Terms concerning attachments, coupling, and the like, such as “connected” and “interconnected,” refer to a relationship wherein structures are secured or attached to one another either directly or indirectly through intervening structures, as well as both movable or rigid attachments or relationships, unless expressly described otherwise. The phrases “operatively” or “operably connected” indicated such an attachment, coupling, or connection that allows the pertinent structures to operate as intended by virtue of that relationship.

Reference throughout the specification to “embodiment,” “one embodiment,” “an embodiment,” or “some embodiment” means that a particular feature, structure, or characteristic is described in connection with at least one embodiment of the subject matter disclosed. Thus, the appearance of the phrases “in one embodiment,” “in an embodiment,” or “in some embodiments” in various places throughout the specification is not necessarily referring to the same embodiment. Further, the particular features, structures or characteristics of “one embodiment,” “an embodiment,” or “some embodiments” may be combined in any suitable manner with each other to form additional embodiments of such combinations. It is intended that embodiments of the disclosed subject matter cover modifications and variations thereof. Terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Moreover, throughout this disclosure, various aspects can be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6, and any whole and partial increments there between. This applies regardless of the breadth of the range. As used herein, the term “about” in reference to a measurable value, such as an amount, a temporal duration, and the like, is meant to encompass variations of plus or minus 20%, plus or minus 10%, plus or minus 5%, plus or minus 1%, and plus or minus 0.1% of the specified value, as such variations are appropriate.

The terms “proximal,” “distal,” “anterior,” “posterior,” “medial,” “lateral,” “superior,” and “inferior” are defined by their standard usage indicating a directional term of reference. For example, “proximal” refers to a position that is situated nearer to the center of a body or point of attachment or interest, while “distal” refers to a position that is situated away from the center of the body or point of attachment or interest. In another example, “anterior” refers to the front of a body or structure, while “posterior” refers to the rear of a body or structure, in relation to a relative viewpoint. In another example, “medial” refers to the direction towards the midline of a body or structure. In some examples, “lateral” or “laterally” may refer to any sideways direction. In another example, “superior” refers to the top of a body or structure, while “inferior” refers to the bottom of a body or structure. It should be understood, however, that the directional term of reference may be interpreted within the context of a specific body or structure, such that a directional term referring to a location in the context of the reference body or structure may remain consistent as the orientation of the body or structure changes.

The terms “user,” “subject,” “individual” and the like are used interchangeably herein and refer to any human, animal, or other living organism, amenable to the systems, devices, and methods described herein.

Described herein is a novel sound bar for use with a percussive musical instrument (such as marimbas, xylophones, and the like) capable of playing two notes of different frequencies or tones, or a combination of the two notes. Also described herein are methods of producing and tuning the sound bar, and a novel musical instrument comprising the sound bars.

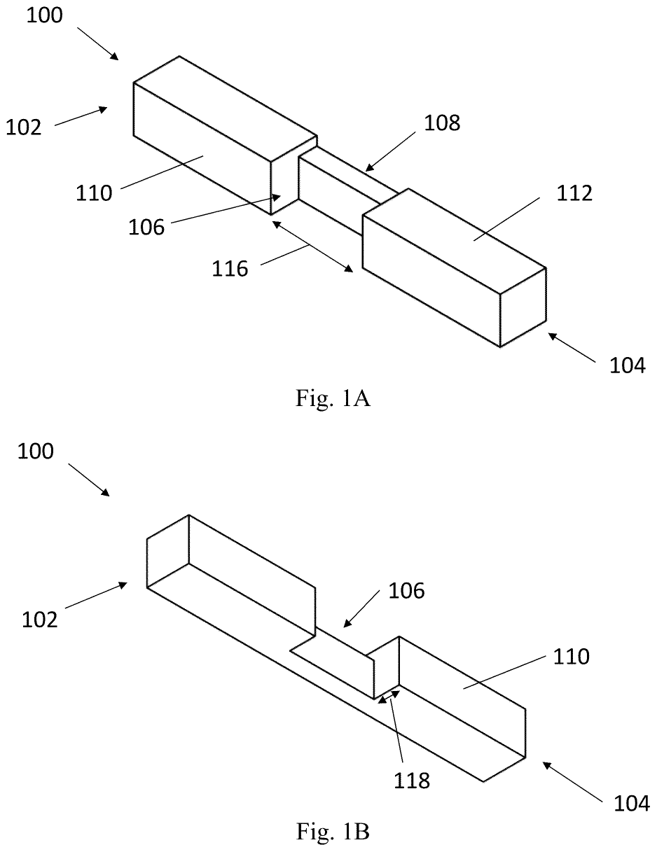

Referring now to FIG. 1, shown are two perspective views of an exemplary sound bar 100. Generally, the sound bar 100 is prismatic in shape, and comprises four lateral faces (two of which are shown in FIGS. 1A and 1B), a first end 102 and a second end 104. The sound bar 100 further comprises a first notch 106 and a second notch 108, wherein the first notch 106 is disposed on a first lateral face 110 and the second notch 108 is disposed on a second lateral face 112. In some embodiments, the first lateral face 110 and the second lateral face 112 are orthogonal to each other.

In some embodiments, the bar 100 may have any length, width, or height suitable for the musical instrument with which it is to be used. For example, the bar 100 may have a length ranging between 5 cm and 200 cm, a width ranging between 1 cm and 10 cm, and a height or thickness ranging between 1 cm and 10 cm. In some embodiments, the sound bar 100 may comprise any suitable rigid material known to one of skill in the art. For example, wood, metals, ceramics, glass, plastics, or polymers may be used. While the materials are described as rigid herein, it should be appreciated that the material should have a certain degree of flexibility to allow for vibrations in the bar. In some embodiments, the sound bar 100 may have a varying thickness throughout the length of the bar. For example, the sound bar 100 may be thicker at the ends, and progressively thinner towards the center of the bar.

In some embodiments, the first notch 106 may have a length 116 of about 0.5 cm, about 1 cm, about 2 cm, about 5 cm, about 10 cm, about 20 cm, about 30 cm, about 40 cm, about 50 cm, about 60 cm, about 70 cm, about 80 cm, about 90 cm, about 100 cm, about 110 cm, about 120 cm, about 130 cm, about 140 cm, about 150 cm, or may have a length in the range of 0.5 cm to 150 cm. It should be appreciated that the length 116 of the first notch 106 must be less than the length of the bar 100. In some embodiments, the first notch 106 may have a depth of about 0.01 cm, about 0.1 cm, about 1 cm, about 2 cm, about 3 cm, about 4 cm, about 5 cm, about 6 cm, about 7 cm, about 8 cm, about 9 cm, about 9.5 cm, or may have a depth in the range of 0 cm to 10 cm. It should be appreciated that the depth of the first notch 106 must be less than width or thickness of the bar 100. In some embodiments, the second notch 108 of about 0.5 cm, about 1 cm, about 2 cm, about 5 cm, about 10 cm, about 20 cm, about 30 cm, about 40 cm, about 50 cm, about 60 cm, about 70 cm, about 80 cm, about 90 cm, about 100 cm, about 110 cm, about 120 cm, about 130 cm, about 140 cm, about 150 cm, or may have a length in the range of 0.5 cm to 150 cm. It should be appreciated that the length of the second notch 108 must be less than the length of the bar 100. In some embodiments, the second notch 108 may have a depth of about 0.01 cm, about 0.1 cm, about 1 cm, about 2 cm, about 3 cm, about 4 cm, about 5 cm, about 6 cm, about 7 cm, about 8 cm, about 9 cm, about 9.5 cm, or may have a depth in the range of 0 cm to 10 cm. It should be appreciated that the depth of the second notch 108 must be less than width or thickness of the bar 100.

In some embodiments, the sound bar 100 comprises two anchoring points for each vibrational mode, positioned at the two vibrational nodes to minimize the dampening of the vibrations when the bar is struck. In some embodiments, the positions of the two vibrational nodes for each of the two vibrational modes can be adjusted to be co-located by modifying notch depths and widths to allow for the optimal mounting configurations of the sound bar 100 to have minimal overall damping. The (center of the) first and second notches 106 and 108 may be positioned at any location along the length of the bar allowing further adjustment of the two anchoring points. In some embodiments, the first and second notches may be positioned at the same distance from an anchoring point or may be positioned at different distances.

In some embodiments, the first and second notches 106 and 108 may be created via any method known to one skilled in art. For example, wood saws, metal cutters, or any other appropriate cutting tool may be utilized. In some embodiments, the sound bar 100 may, for example, be 3D printed with the notches in place.

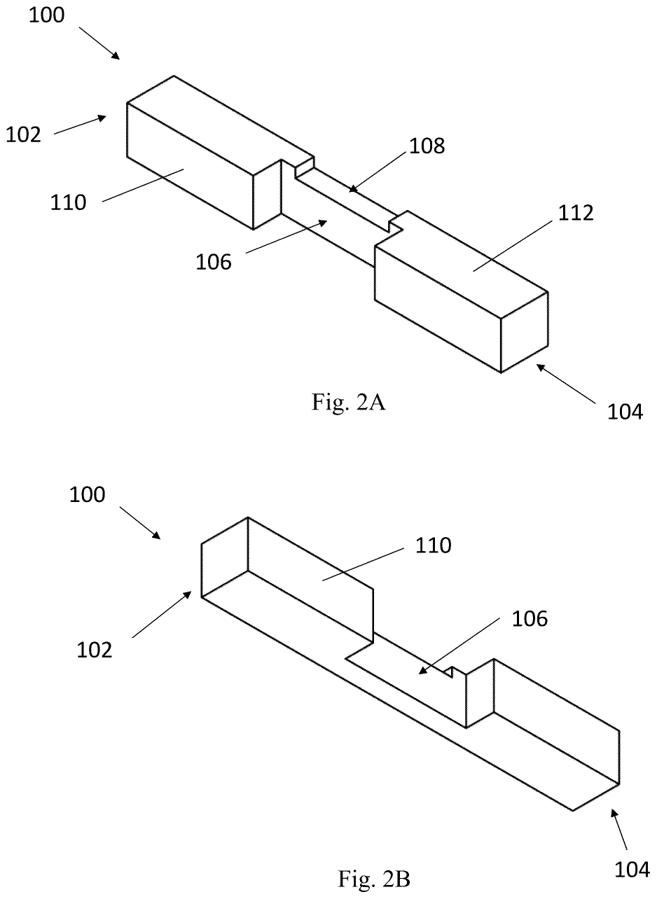

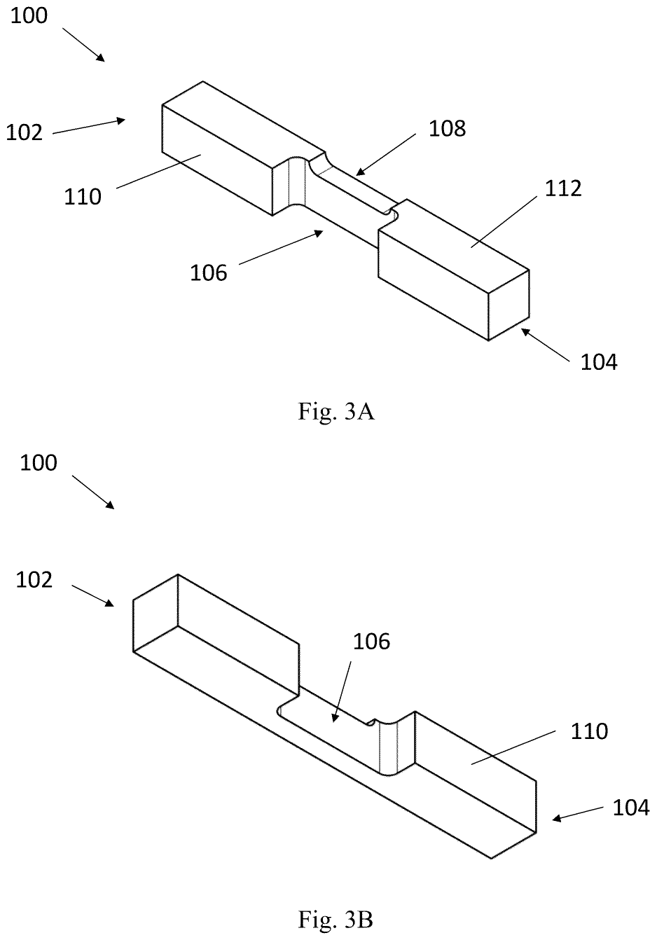

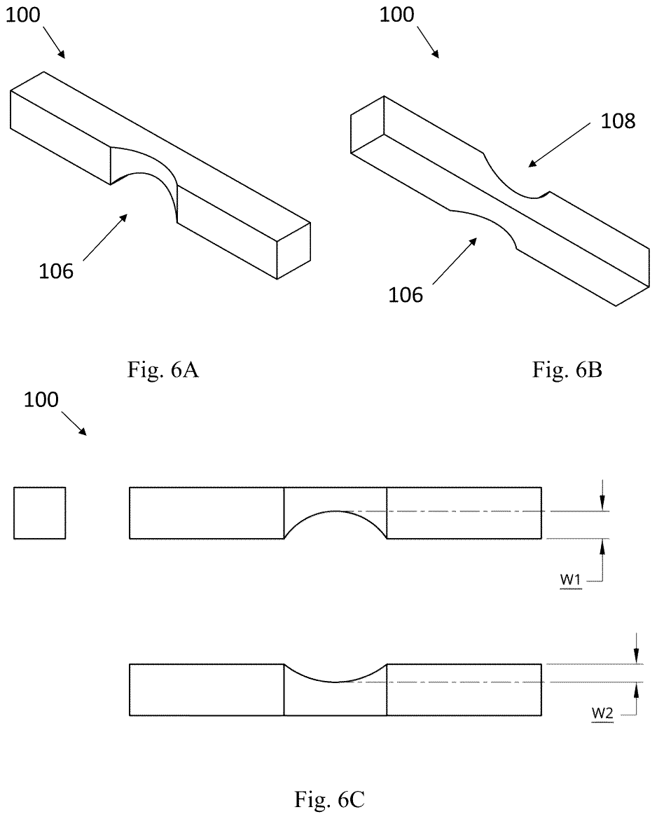

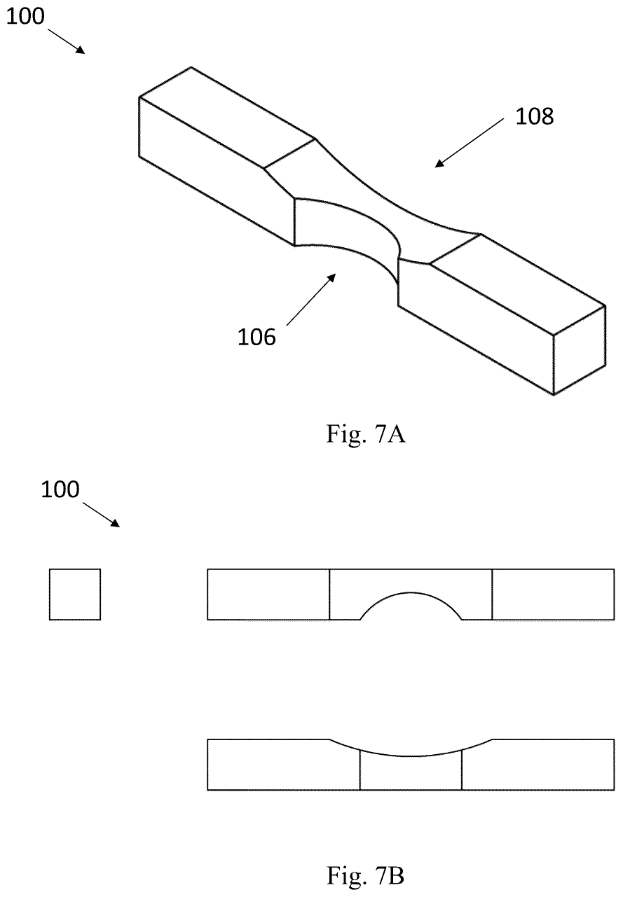

It should be appreciated that the first notch 106 and the second notch 108 may not necessarily have the same lengths or depths. Referring to FIG. 1, shown is an exemplary sound bar 100 with first notch 106 and second notch 108 having the same length, but different depths. Referring now FIG. 2 shown is an exemplary sound bar 100 with first and second notches 106, 108 of different lengths and depths. In some embodiments, and referring now to FIGS. 3A and 3B, the first and second notches 106, 108 may have rounded edges, or may have a combination of sharp and rounded edges (not pictured). In some embodiments, and referring now to FIGS. 6A-6C, the first and second notches 106 and 108 may be curved. The curved notches may have different lengths, different depths as (depicted in FIGS. 6A-6C), or may have different depths and lengths (as depicted in FIGS. 7A and 7B)

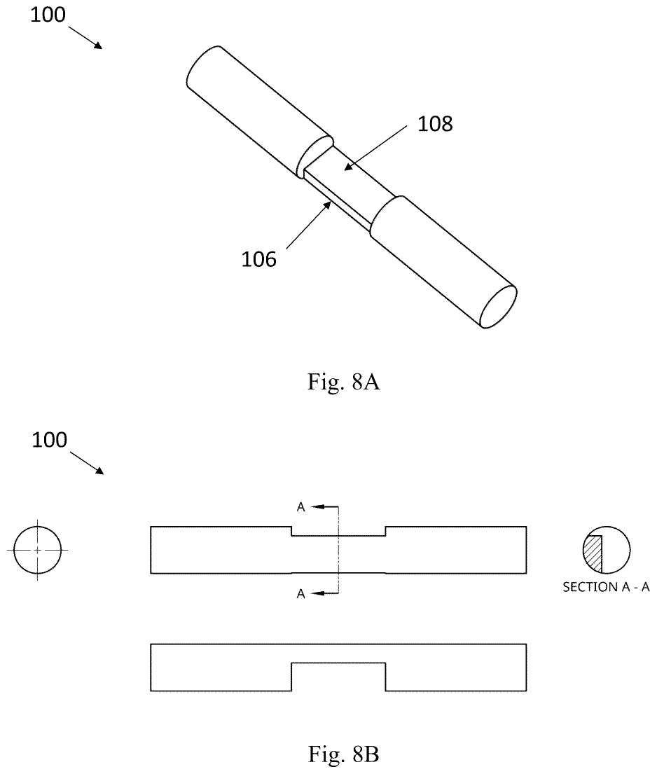

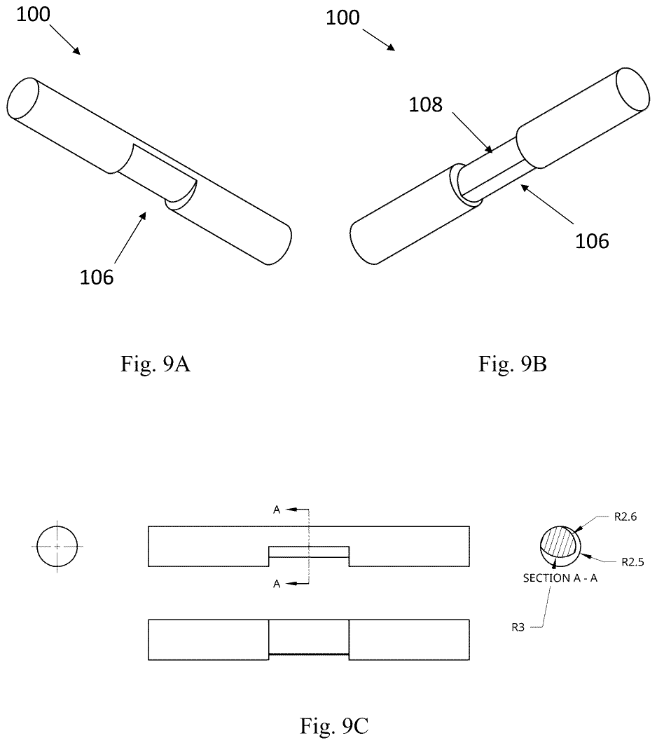

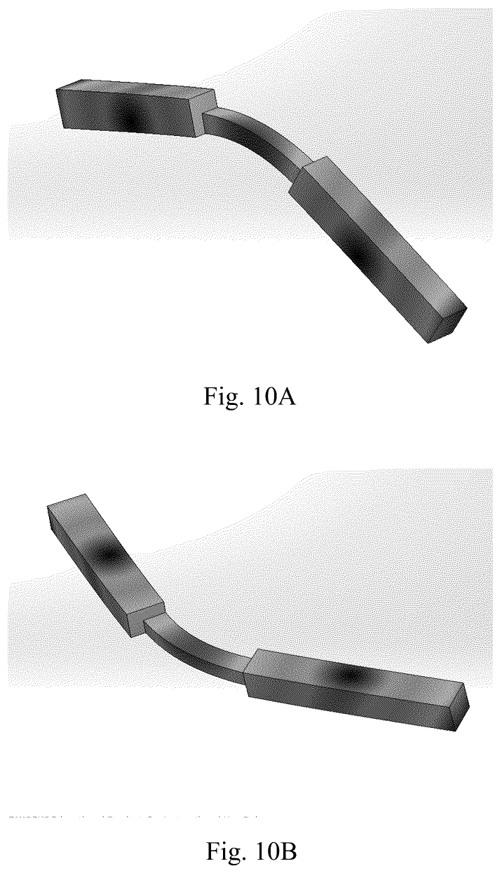

In some embodiments, the sound bar 100 may have any desired shape known to one of skill in the art. For example, the sound bar 100 may be pyramidal, cuboidal, polygonal, cylindrical, or any combinations thereof. FIGS. 8A and 8B depict a cylindrical sound bar 100 with linearly cut notches 106 and 108. FIGS. 9A-9C depict a cylindrical sound bar 100 with radially cut notches 106 and 108.

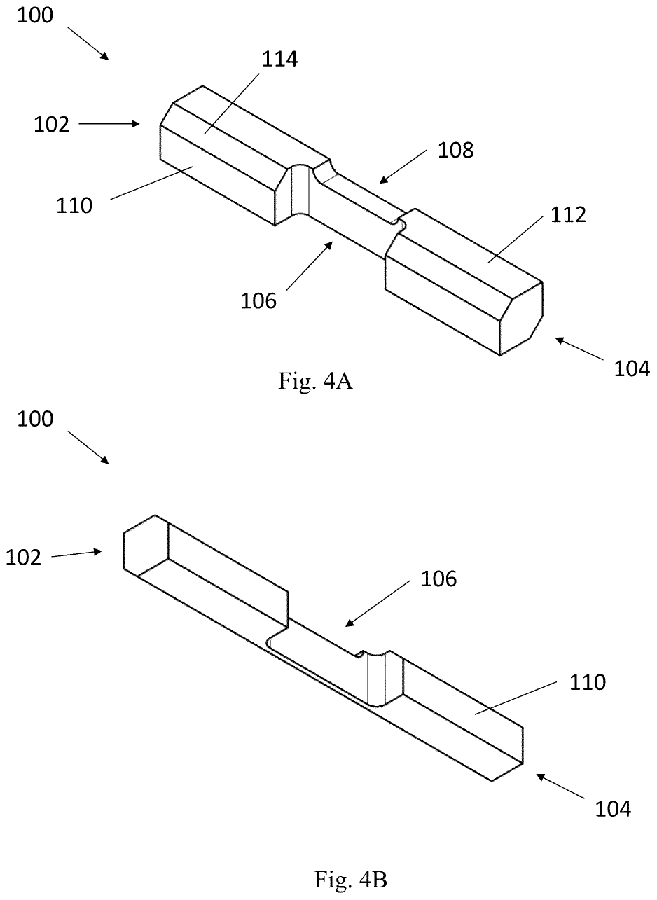

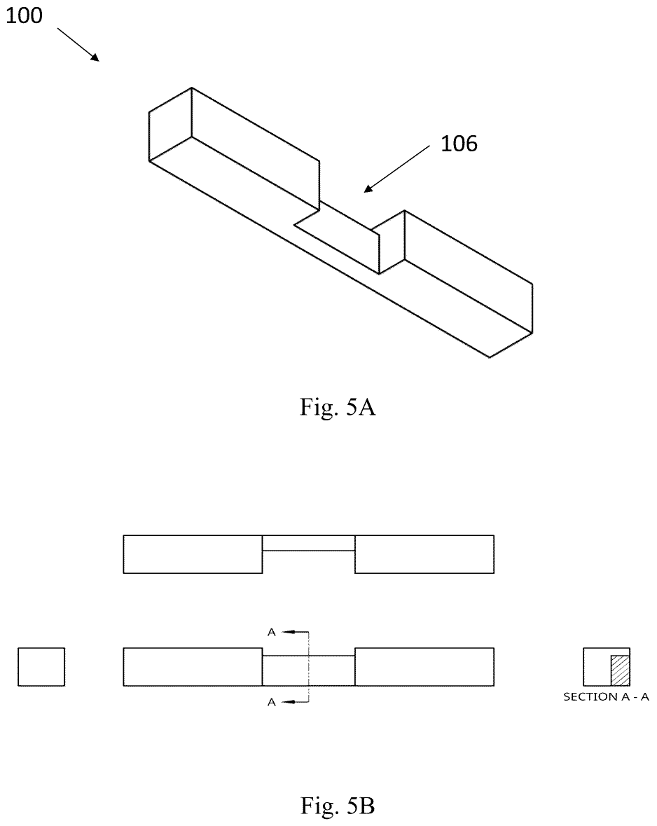

In some embodiments, striking the sound bar 100 on the first face 110 comprising first notch 106 produces a pitch with a first frequency. In some embodiments, striking the sound bar 100 on the second face 112 comprising the second notch 108 produces a pitch with a second frequency. In some embodiments, striking the bar on a third face (see FIGS. 4A and 4B) or an edge produces a note with a combination of the first and second frequencies. In some embodiments, adjusting the length and/or depth of the first and second notches modifies the frequency of the note produced via striking the sound bar on the first and/or second face. In some embodiments, increasing the depth of a notch decreases the frequency of the associated pitch. In some embodiments, increasing the length of a notch decreases the frequency of the associated pitch. In some embodiments, increasing the length of a notch may increase the frequency of the associated pitch for notch lengths comparable to the overall bar length. In some embodiments, the two frequencies produced by the first and second face of the sound bar 100 may be adjusted to any desired frequency, hence producing two notes that may be related by any specified musical interval (for e.g. a fourth a fifth, an octave, and the like). In some embodiments, the two frequencies may be adjusted so that the notes produced by each face are in a different musical key or scale (for e.g. a major scale, a minor scale, a pentatonic scale, and the like). In some embodiments, the two frequencies may be adjusted such that they have a similar frequency, thereby producing beating effects resulting in a natural tremolo.

Referring now to FIGS. 4A and 4B, shown is an exemplary sound bar 100 comprising a third face 114 between the first face 108 and the second face 110. In some embodiments, the third face 114 may be formed via flattening the edge between the first face 110 and second face 112. In some embodiments, striking the sound bar on the third face 114 produces a note with a combination of the first frequency and the second frequency.

Also described herein is a percussive musical instrument comprising at least one sound bar as described above. The percussive musical instrument comprises a mechanism capable of rotating the sound bars such that the two faces 110 and 112, and/or the third face 114 may face the user such that the appropriate face may be struck to produce the different tones while the instrument is being played.

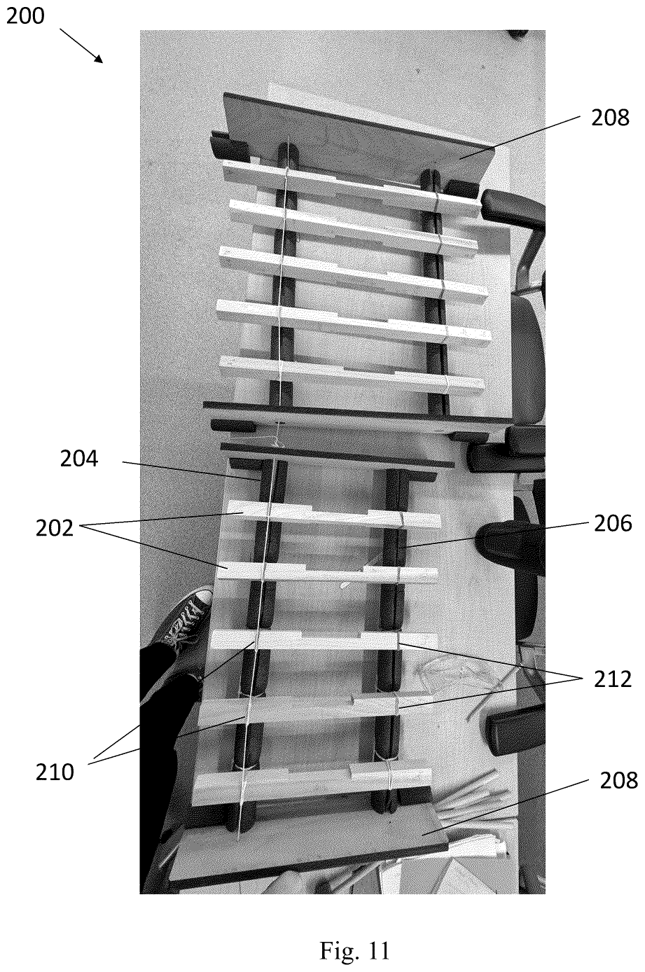

Referring now to FIG. 11, shown is an exemplary musical instrument 200, comprising a plurality of sound bars 202 as described above, a first base rod 204 attached to a first position 210 of each sound bar and a second base rod 206 attached to a second position 212 of each sound bar. In some embodiments, the first and second positions may be near the first and second ends of the sound bars 202, respectively. It should be appreciated that the first and second positions correspond to the oscillation nodes of the sound bars, at which point minimal vibrations occur in the sound bar. In some embodiments, the first and second positions 210 and 212 may be adjusted to be at desired locations along the length of the sound bar. In some embodiments, the first and second notches in each sound bar of the plurality of sound bars 202 are positioned between the first and second positions 210 and 212.

In some embodiments, the base rods 204 and 206 comprise a generally rigid material including, but not limited to, wood, metals, ceramics, glass, or plastics. In some embodiments, the base rods 204 and 206 are covered with a soft material. In some embodiments, the soft material may comprise foam, rubber, silicone, soft polymers and the like. In some embodiments, the base rods 204 and 206 are configured to fit within and/or fixedly attach to a frame 208. For example, the attachment may comprise glues, adhesives, flexible cords, welding, screws, or any other suitable attachment for a fixed attachment.

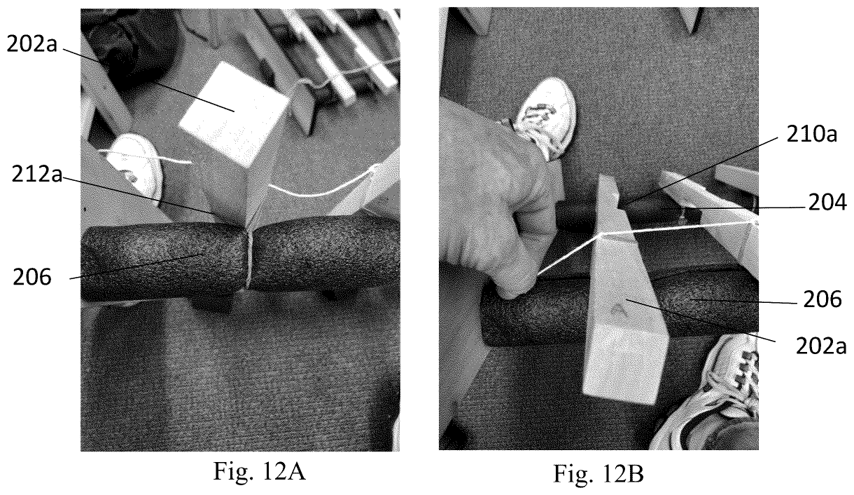

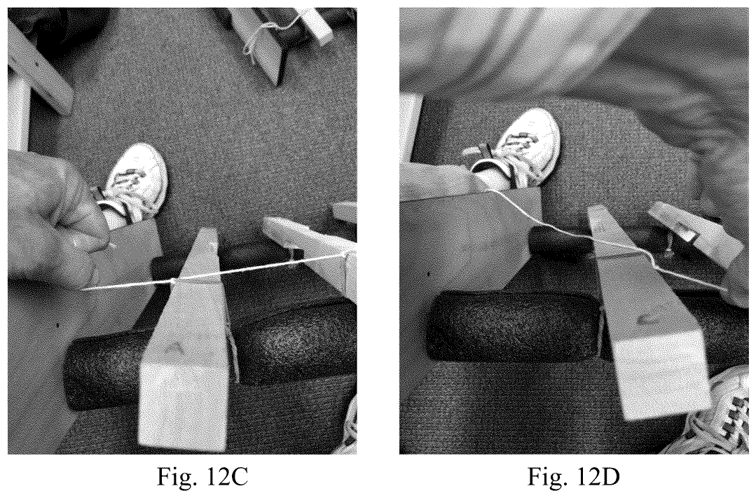

Referring now to FIGS. 12A and 12B, shown is an exemplary flexible attachment between a sound bar 202a of the plurality of sound bars 202 and the first and second base rods 204 and 206, at positions 210a and 212a respectively. In some embodiments, the sound bar 202a may be flexibly attached to the base rods 204 and 206, such that the bar 202a has a rotational degree of freedom. The flexible attachment may comprise any suitable mechanism known to one of skill in the art. For example, rubber bands, strings, universal joints, or polyurethane universal joints may be used. It should be appreciated that the attachments must be robust enough to withstand repeated deformations. FIGS. 12C and 12D depict additional perspectives of the flexible attachment.

In some embodiments, the musical instrument 200 may comprise a rotational mechanism configured such that each sound bar of the plurality of sound bars 202 may rotate about an axis of rotation parallel to the length of the sound bar, wherein the length of each sound bar extends from the first end 102 to the second end 104 (see FIGS. 1A and 1B). In some embodiments, the plurality of sound bars 202 may be rotated about 10 degrees, about 20 degrees, about 30 degrees, about 40 degrees, about 50 degrees, about 60 degrees, about 70 degrees, about 80 degrees or about 90 degrees. The rotational mechanism may comprise any mechanism known to one of skill in the art that would allow the plurality of sound bars 202 to rotate such that different faces may face the user while the user is playing the instrument. For example, and as depicted in FIGS. 11 and 12A-12D, a string or cord may be utilized, such that the string is attached to each sound bar of the plurality of sound bars 202 at each position 212. In some embodiments, the string is configured such that pulling the string in one direction allows the sound bar to rotate in the same direction. The string may be configured to have trailing ends, or be loosely attached to the frame 208, such that when the string is pulled to one side, the plurality of sound bars may rotate in the direction.

In some embodiments, each sound bar of the plurality of sound bars 202 may be operated via the same rotational mechanism, such that each sound bar may be rotated about the same angle. In some embodiments, one or more subsets of the plurality of sound bars are operated via separate rotational mechanisms, such that the one or more subsets may be separably rotatable about different angles. In some embodiments, each sound bar of the plurality of sound bars is operated via separate rotational mechanisms, such that each sound bar may be rotated individually.

In some embodiments, the musical instrument may further comprise a resonant tube system positioned underneath the musical instrument 200 capable of enhancing the volume and timbre of the vibrations of the plurality of sound bars 202. In some embodiments, the resonant tube system may selectively enhance either the first, the second, or both notes produced by each of the sound bars of the plurality of sound bars 202.

It should be appreciated that other configurations of a musical instrument using the sound bars are possible. For example, the sound bars may be used as hanging chimes, may be configured as a tuning fork, or may be fixedly attached at one end.

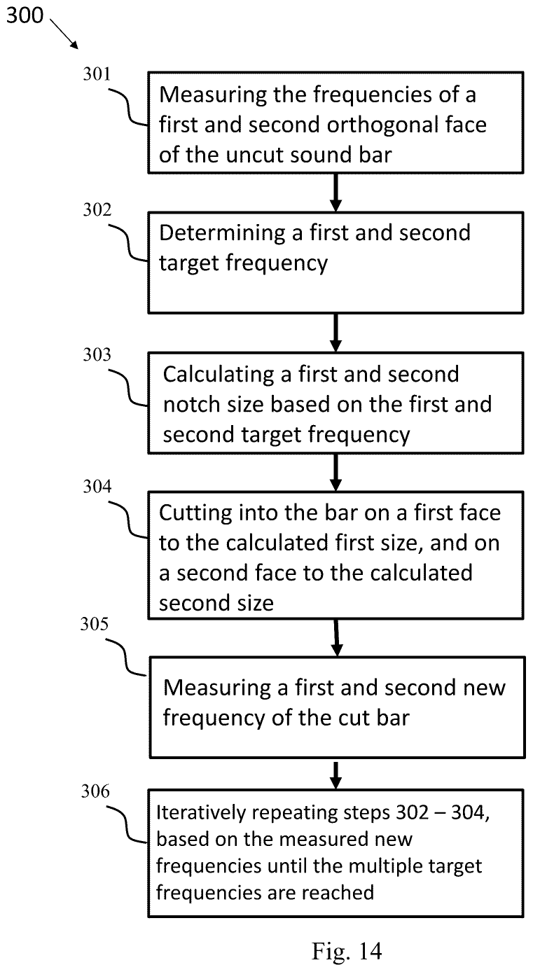

Also described herein is a method 300 of producing and tuning sound bars to multiple target frequencies. Referring now to FIG. 14, the method comprises the steps of: measuring the frequencies of a first and second orthogonal face of an uncut sound bar (301), determining a first and a second target frequency (302), calculating a first and second notch depth based on the first and second target frequency (303), cutting into the bar on a first face to 90-95% of the calculated first depth, and on a second face to 90-95% the calculated second depth (304), measuring a first and second new frequency of the cut bar (305), and iteratively repeating steps 302-304 based on the measured new frequencies until the multiple target frequencies are reached. Generally, two iterations suffice to tune the frequencies to within 10 cents, but more may be performed to achieve the desired tuning accuracy. In some embodiments, the method 300 produces node locations for the two vibrational modes that are naturally close in location. In some embodiments, an iterative procedure may be used to produce nodes that are adjustable in location by varying the notch lengths along with the notch depths.

In some embodiments, the method 300 tunes the sound bar to less than 1 cent, less than 2 cents, less than 3 cents, less than 4 cents, less than 5 cents, less than 6 cents, less than 7 cents, less than 8 cents, less than 9 cents, less than 10 cents, or between 0 cents and 10 cents. In some embodiments, the steps of calculating the first and second notch depths comprise calculating the depths based on a mathematical relationship between the geometric parameters of the uncut sound bar, the notch depths and lengths and the desired frequencies. The mathematical relationship is generated from a computer model that performs simulations that relate the two vibrational frequencies to two notch depths, for fixed notch lengths and overall bar dimensions. The results from a finite number of notch depth combinations are used to parametrize two polynomial formulas which yield each of the vibrational frequencies as a function of any two notch depths to very good accuracy. In some embodiments, a computer model may be used to generate frequency simulations based on the geometric parameters (length, width, and thickness) of the uncut sound bar, the notch depths and lengths, and hence determine the corresponding notch lengths that produce nodes in desired locations.

### EXPERIMENTAL EXAMPLES

The invention is further described in detail by reference to the following experimental examples. These examples are provided for purposes of illustration only and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the present invention and practice the claimed methods. The following working examples therefore are not to be construed as limiting in any way the remainder of the disclosure.

### Example 1: Bar Cutting Procedure

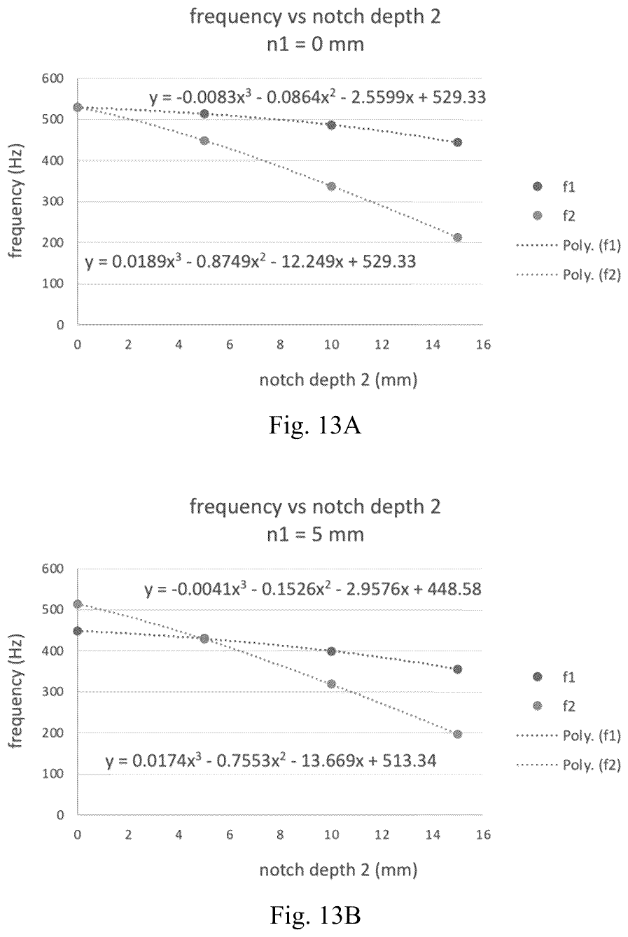

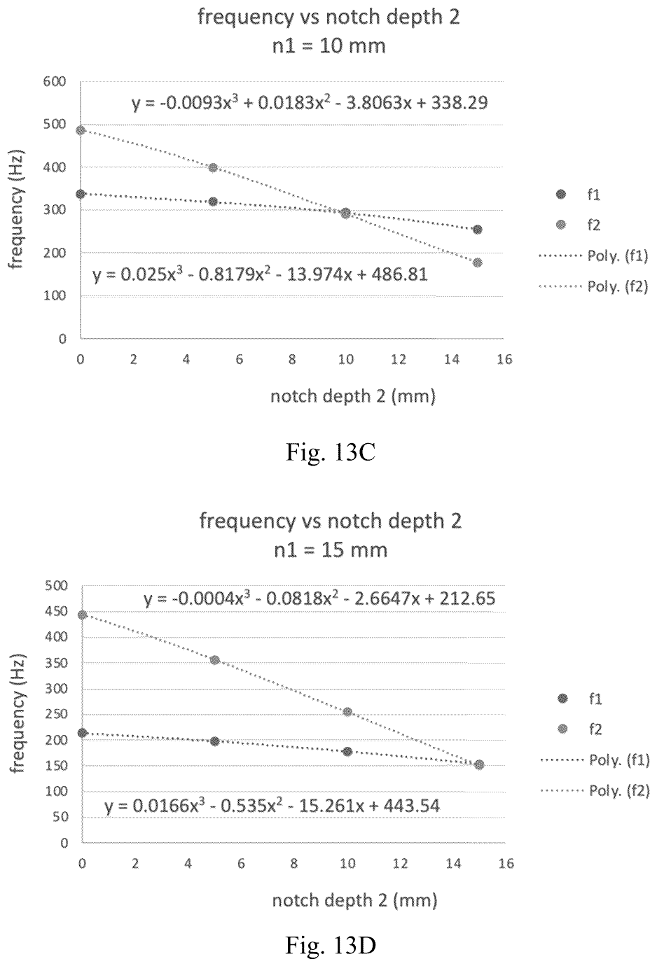

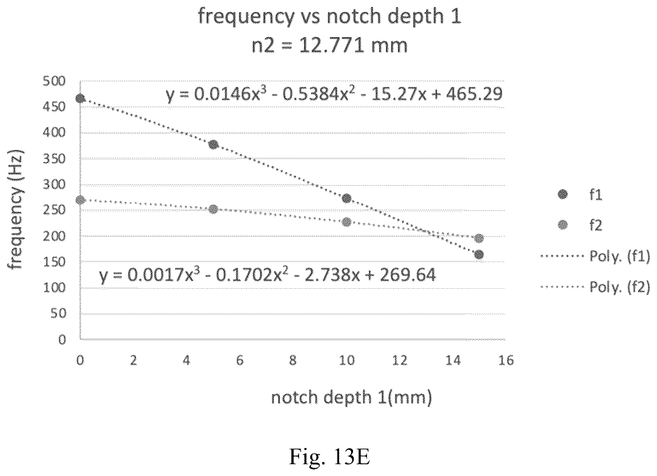

Before proceeding to cut the bar, simulations are performed that determine the two lowest vibrational frequencies of the bar as a function of the bar geometry and dimensions. By performing these simulations for a finite number of notch depth combinations, polynomial formulas may be derived using standard techniques to relate the two frequencies to two arbitrary notch depths (with all other aspects of the geometry fixed). Additionally, standard techniques may be used to invert these formulas to calculate the two notch depths required to yield two desired vibrational frequencies. One embodiment for how this may be done is illustrated in FIGS. 13-16. Table 1 shows the simulation results for a bar having the geometry shown in FIG. 1, with two rectangular notches of the same width but different depths.

TABLE 1

| | | | Notch | Notch | Notch | | | Scaled to | |
|---|---|---|---|---|---|---|---|---|---|
| Length | w1 | w2 | length | w1 | w2 | f1 | f2 | actual bar | |
| 495.86 | 25.54 | 25.54 | 100 | 0 | 0 | 547 | 547 | 529.330 | 529.330 |
| 495.86 | 25.54 | 25.54 | 100 | 0 | 5 | 529.5 | 468.7 | 512.395 | 453.559 |
| 495.86 | 25.54 | 25.54 | 100 | 0 | 10 | 501.1 | 357.4 | 484.913 | 345.855 |
| 495.86 | 25.54 | 25.54 | 100 | 0 | 15 | 455.5 | 238.1 | 440.786 | 230.409 |
| 495.86 | 25.54 | 25.54 | 100 | 5 | 0 | 468.7 | 529.5 | 453.559 | 512.395 |
| 495.86 | 25.54 | 25.54 | 100 | 5 | 5 | 448.3 | 447.3 | 433.818 | 432.851 |
| 495.86 | 25.54 | 25.54 | 100 | 5 | 10 | 416.4 | 335.7 | 402.949 | 324.856 |
| 495.86 | 25.54 | 25.54 | 100 | 5 | 15 | 370.8 | 220.3 | 358.822 | 213.184 |
| 495.86 | 25.54 | 25.54 | 100 | 10 | 0 | 357.4 | 501.1 | 345.855 | 484.913 |
| 495.86 | 25.54 | 25.54 | 100 | 10 | 5 | 335.7 | 416.4 | 324.856 | 402.949 |
| 495.86 | 25.54 | 25.54 | 100 | 10 | 10 | 308.4 | 306.4 | 298.438 | 296.502 |
| 495.86 | 25.54 | 25.54 | 100 | 10 | 15 | 266.9 | 197.7 | 258.278 | 191.314 |
| 495.86 | 25.54 | 25.54 | 100 | 15 | 0 | 238.1 | 455.5 | 230.409 | 440.786 |
| 495.86 | 25.54 | 25.54 | 100 | 15 | 5 | 220.3 | 370.8 | 213.184 | 358.822 |
| 495.86 | 25.54 | 25.54 | 100 | 15 | 10 | 197.7 | 266.9 | 191.314 | 258.278 |
| 495.86 | 25.54 | 25.54 | 100 | 15 | 15 | 168.7 | 167.8 | 163.250 | 162.379 |

In this example, the outside dimensions of the bar was 25.54 mm×25.54 mm×495.9 mm, and the length of the notches was 100 mm. The simulation was performed for all combinations of notch depths ranging from 0-15 mm in 5 mm increments, as shown in Table 1. The frequency results shown have been rescaled by a uniform constant so that the measured frequencies for a bar with no notches match those of the simulation. In this embodiment, a polynomial formula of degree 3 was used to fit each of the two vibrational frequencies as a function of notch depth 2 for fixed values of notch depth 1. Then, for a specified arbitrary value of notch depth 2, these formulas yielded the two frequencies for that notch depth for fixed values of notch depth 1, and these were used to determine polynomial fits that ultimately specified the two vibrational frequencies as a function of two arbitrary notch depths. (FIGS. 13A-13E). Tables 2 and 3 show the results of all these formulas for the frequencies (far right) given specified notch depths (far left).

TABLE 2

| n1 | f1 3 | f1 2 | f1 1 | f1 0 | f2 3 |
|---|---|---|---|---|---|
| 0 | −0.008283107 | −0.08638098 | −2.5598746 | 529.33 | 0.01893282 |
| 5 | −0.004128406 | −0.15264583 | −2.9575952 | 448.579565 | 0.01744712 |
| 10 | −0.009269192 | 0.018341166 | −3.806285 | 338.286047 | 0.0249545 |
| 15 | −0.000420729 | −0.08184499 | −2.6647282 | 212.649058 | 0.01660566 |

| n1 | f2 2 | f2 1 | f2 0 | f1(n2) | f2(n2) |
|---|---|---|---|---|---|
| 0 | −0.8748539 | −12.249138 | 529.33 | 465.293501 | 269.637208 |
| 5 | −0.7553405 | 13.669428 | 513.335714 | 377.3100165 | 251.902507 |
| 10 | −0.8178582 | −13.974457 | 486.810049 | 273.3579928 | 226.922662 |
| 15 | −0.5350493 | −15.260639 | 443.540674 | 164.3912099 | 195.963632 |

TABLE 3

| f1(n2)3 | f1(n2)2 | f1(n2) 1 | f1(n2)0 | f2(n2)3 | f2(n2) 2 | f2(n2) 1 | f2(n2)0 | f1(n1, n2) | f2(n1, n2) |
|---|---|---|---|---|---|---|---|---|---|
| 0.01460504 | −0.53844638 | −15.269591 | 465.293501 | 0.00168795 | −0.1702221 | −2.7380286 | 269.637208 | 367.9000881 | 249.81001 |
| n1 | n2 | | | | f1 target | f2 target | R squared | | |
| 5.477 | 12.771 | | | | 367.9 | 249.81 | 7.8538E−9 | | |

To invert these formulas, an error value may be calculated between two specified frequencies and the calculated frequencies (defined to be the root mean square difference between the two sets of frequencies), and the spreadsheet solver may be used to vary the notch depths until the error value is minimized to close to zero. With these formulas in hand, the following procedure is carried out:

Step 1: Decide on two target frequencies, f1 and f2, that are lower than the frequencies of the uncut bar. Step 2: Using the above fitting/inversion techniques, determine the depths of the notches required to achieve these desired frequencies. Call these n1′ and n2′. Step 3: Multiply these depths by 95% and cut those sides by that amount. Step 4: Measure the frequencies of the cut bar. Step 5: Use the frequencies and the fitting/inversion to determine the corresponding notch depths (These will generally not agree perfectly with the actual cut depths). Step 6: Subtract these from n1′ and n2′ and multiply each of those by 95%. Cut the notches by the additional amount calculated in step 6. This iterative procedure should tune the bar within 5-10 cents. If further accuracy is desired, continue to iterate steps 4-6. The value 95% is chosen because non-uniform materials such as wood can result in errors in the frequencies. (The simulation assumes uniform materials). Cutting the depths short of the calculated depths results in the tuning to be purposely sharp, even with some material or cutting error. The second iteration uses the measured frequencies and smaller additional cuts to bring the tuning closer to optimal. If the results are still sharp, a third iteration may be used. If the material is so non-uniform that the first cut results in frequencies that are too flat, a more conservative value for the cut percentage (e.g. 90% versus 95%) should be used, with more iterations possibly required to achieve the final tuning.

### Example 2: Linkages for Flipping the Bars by 90 Degrees in Each Direction

The square bars rest on a base rod covered by a soft material (in FIGS. 12A and 12B) shown as pipe insulation but could be other foams or rubbers. The bars are attached to the rod at one corner (seen in FIG. 12A) with a flexible joint that allows them to flip back and forth by 90 degrees (shown in FIG. 12B with rubber bands, but other soft connections allowing this degree of freedom are possible).

At the opposite corner, a string (or other flexible cord of any material) is attached with a flexible joint with the same flexibility (shown in FIG. 12B). When the string is pulled to the right or left, the bar flips to that side. All the bars are connected to the base rod in the same way and are attached at the top with the cord daisy-chained to all in turn. This allows all the bars to be flipped at the same time. Other attachments at the top could be added to allow different combinations to be flipped (e.g. every other one). It is important that all the above attachments occur at the two nodes of the vibrational oscillations (determined to be a specific distance from each end of the bar).

Rather than rubber bands, the bottom connections can be nylon or other strings that are robust under repeated deformation. They could be small versions of polyurethane universal joints as are used in sailboard mast-board connections. The top connections may be strings made from nylon or other soft materials. Small diameter steel braided cords may be possible.

Other geometric possibilities for the bars that use the same double-notch tuning strategy: Fixed at one end, as is done on small music boxes, tuning fork configurations, or hanging chimes.

The disclosures of each and every patent, patent application, and publication cited herein are hereby each incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A sound bar comprising:
a prismatic bar having four faces, a first end and a second end;
a first notch on a first face of the bar; and
a second notch on a second face of the bar;
wherein the first face is orthogonal to the second face.

2. The sound bar of claim 1, wherein the length of the bar ranges between 1 and 200 cm, the width ranges between 1 and 10 cm, and the height ranges between 1 and 10 cm.

3. The sound bar of claim 1, wherein the first notch has a length ranging between 0.5 and 150 cm, and a depth ranging between 0 and 9.5 cm.

4. The sound bar of claim 1, wherein the second notch has a length ranging between 0.5 and 150 cm, and a depth ranging between 0 and 9.5 cm.

5. The sound bar of claim 1, wherein the sound bar is configured to produce a note having a first frequency when the first face is struck.

6. The sound bar of claim 5, wherein the sound bar is configured to produce a second note having a second frequency different from the first frequency when the second face is struck.

7. The sound bar of claim 6, further comprising a fifth face positioned between the first and second orthogonal faces.

8. The sound bar of claim 7, wherein the sound bar is configured to produce a note having a combination of the first and second frequencies when the fifth face is struck.

9. The sound bar of claim 6, wherein the frequencies of the first note and the second note are adjustable.

10. The sound bar of claim 9, wherein the first note and the second note may be related by a specified musical interval.

11. The sound bar of claim 1, further comprising first and second anchoring points at which the bar is secured to an external structure, wherein the position of the first and second anchoring points are adjustable.

12. A method of making and tuning a sound bar to multiple target frequencies, comprising:
(a) measuring the frequency of an uncut sound bar;
(b) determining a first and a second target frequency;
(c) calculating a first and a second notch size based on the first and second target frequency;
(d) cutting into the bar on the first face to the calculated first size, and on the second face to the calculated second size;
(e) measuring the first and second new frequencies of the cut bar; and
(f) iteratively repeating the steps (a)-(e) based on the measured new frequencies until the multiple target frequencies are reached.

13. A musical instrument comprising:
one or more sound bars, each sound bar comprising:
a prismatic bar having four faces, a first end and a second end;
a first notch on a first face of the bar; and
a second notch on a second face of the bar;
wherein the first face is orthogonal to the second face; and
a first base rod and a second base rod positioned parallel to each other;
wherein the one or more sound bars are positioned perpendicular to the base rods, and each sound bar is attached at a first position to the first base rod, and at a second position to the second base rod.

14. The musical instrument of claim 13, wherein the first and second base rods are covered by a soft material chosen from the group consisting of foam, rubber, silicone, and soft polymers.

15. The musical instrument of claim 13, further comprising a rotating mechanism configured to rotate the one or more sound bars.

16. The musical instrument of claim 15, wherein the one or more sound bars are rotatable about 10°, about 20°, about 30°, about 40°, about 50°, about 60°, about 70°, about 80°, or about 90°.

17. The musical instrument of claim 15, wherein the one or more of sound bars are collectively rotatable about the same angle.

18. The musical instrument of claim 15, wherein one or more subsets of the one or more sound bars are separably rotatable about different angles.

19. The musical instrument of claim 15, wherein each sound bar of the one or more sound bars is separably rotatable about different angles.

20. The musical instrument of claim 13, further comprising a resonant tube system configured to enhance the volume or timbre of the notes produced by the plurality of sound bars.
